(19) United States
(12) Patent Application Publication
(10) Pub. No.: US 2007/0211963 A1
(43) Pub. Date: Sep. 13, 2007

(54) Integrated circuit, image processing apparatus, method of controlling clock signal and clock signal control program

(75) Inventor: Junji Yamada, Yokohama-shi (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Shinagawa-ku (JP)

(21) Appl. No.: 11/371,428

(22) Filed: Mar. 8, 2006

(51) Int. Cl. G06K 9/54

(52) U.S. Cl. 382/304

(57) ABSTRACT

There are provided an integrated circuit that can easily realize efficient reduction of power consumption of an ASIC with a simple configuration without requiring control of a sleep function by a CPU and an image processing apparatus including the integrated circuit. The integrated circuit includes plural processing blocks for performing, on the basis of clock signals and image valid signals inputted, predetermined processing concerning image data signals inputted and sequentially outputs results of processing in processing blocks at pre-stages to the processing blocks at post-stages. The integrated circuit includes a processing completion judging section that judges completion of processing concerning an image data signal in each of the plural processing blocks and a clock signal control section that controls, when the processing completion judging section judges that the processing is completed, a frequency of a clock signal inputted to the processing block in which the processing is completed to be a second frequency lower than a first frequency of a clock signal that should be inputted when the predetermined processing is performed in the processing block.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by any one of the patent disclosure as it appears in the Patent and Tredemark Office patent files or records, but otherwise reservesm all copyright and trade dress rights whatsoever.

### BACKGROUND OF THE INVENTION

1. Field of the Invention

The present invention relates to an integrated circuit and an image processing apparatus including the integrated circuit, and, more particularly to control of a clock signal in the integrated circuit.

2. Description of the Related Art

In an electrical configuration of an image processing apparatus (Multi Function Peripheral (MFP)) or the like that performs image formation processing, image reading processing, and the like, since circuits are integrated in an Application Specific Integrated Circuit (ASIC), power consumption of the ASIC significantly affects power consumption in the entire image processing apparatus.

Conventionally, when image processing in the image processing apparatus is not performed, as a sleep (clock stop) function, a CPU judges an operation state of the image processing apparatus and, in the ASIC on the electrical configuration, starts the sleep function with respect to a processing block in which it is possible to stop a clock and stops an internal circuit operation to reduce power consumption.

In such a conventional sleep function, when the clock is stopped in the ASIC, to prevent problems in an operation of the image processing apparatus, circuits are constituted such that a state of data or the like at the time when the clock is stopped is held and, when the clock is reset from the stop, the operation is resumed from the state of the data or the like held.

However, when the CPU controls the sleep function, since the CPU controls the sleep function judging from an operation state of the entire image processing apparatus, it is difficult to perform power consumption control by fine stop control. Therefore, in the configuration for controlling the sleep function with the CPU, there is a problem in that efficient low power consumption control is difficult.

### DESCRIPTION OF THE DRAWINGS

FIG. 1 is a block diagram showing a configuration of an integrated circuit according to a first embodiment of the invention;

FIG. 2 is a diagram showing changes in main scanning valid signals and sub-scanning valid signals serving as image valid signals at the time when an image data signal inputted to a processing block 100A is sequentially passed to processing blocks at post-stages;

FIG. 3 is a diagram showing changes in main scanning valid signals and sub-scanning valid signals serving as image valid signals at the time when an image data signal inputted to a processing block 100A is sequentially passed to processing blocks at post-stages;

FIG. 4 is a diagram for explaining judgment of completion of processing in the processing blocks based on the image valid signals and frequency control for clock signals;

FIG. 5 is a block diagram showing a configuration of an integrated circuit according to a second embodiment of the invention; and

FIG. 6 is a flowchart for explaining a flow of processing (a clock signal control method) in the integrated circuits according to the first and the second embodiments.

### DETAILED DESCRIPTION OF THE INVENTION

Throughout this description, the embodiments and examples shown should be considered as exemplars, rather than limitations on the apparatus, methods and programs of the present invention.

In integrated circuits according to embodiments of the invention, since an ASIC itself performs control, respective processing blocks in the ASIC judge processing function states of the respective processing blocks using image valid signals and image data inputted and perform switching control for a clock period switching function of a clock according to automatic control. Consequently, finer low power consumption control is performed without requiring control by a CPU or the like during operations of the respective processing blocks in the ASIC (a state in which a stop function or the like of the clock is not started).

A signal used for judgment in the automatic control is created from a signal form identical with that of the ASIC not having the present clock period switching function and controlled. Since it is judged whether respective functions of the ASIC itself are operating according to signals for performing image data processing such as image valid signals (main scanning valid signals, sub-scanning valid signals, etc.), in particular, there is also an advantage that addition or the like of a control signal for the invention is not required.

### FIRST EMBODIMENT

A first embodiment of the invention will be hereinafter explained with reference to the accompanying drawings.

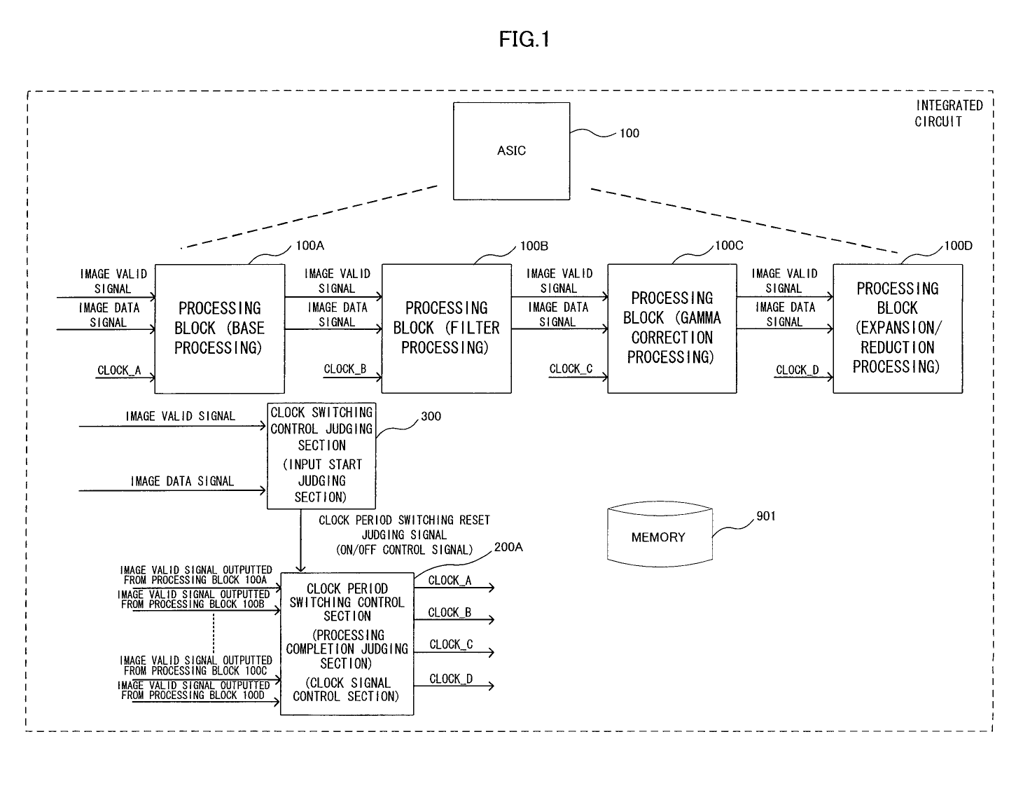

FIG. 1 is a block diagram showing a configuration of an integrated circuit according to the first embodiment of the invention. The integrated circuit shown in FIG. 1 has an electrical configuration integrated by an ASIC 100. Specifically, the integrated circuit according to this embodiment includes processing blocks 100A to 100D, a clock period switching control section (a processing completion judging section and a clock signal control section) 200A, and a clock switching control judging section (an input start judging section) 300.

The processing blocks 100A to 100D have a role of sequentially outputting processing results in the processing blocks at pre-stages to processing blocks at post-stages. An image data signal inputted to the processing block 100A is processed in the processing block 100B, the processing block 100C, and the processing block 100D in this order. In this way, the respective processing blocks perform, on the basis of clock signals and image valid signals inputted, predetermined processing concerning image data signal inputted.

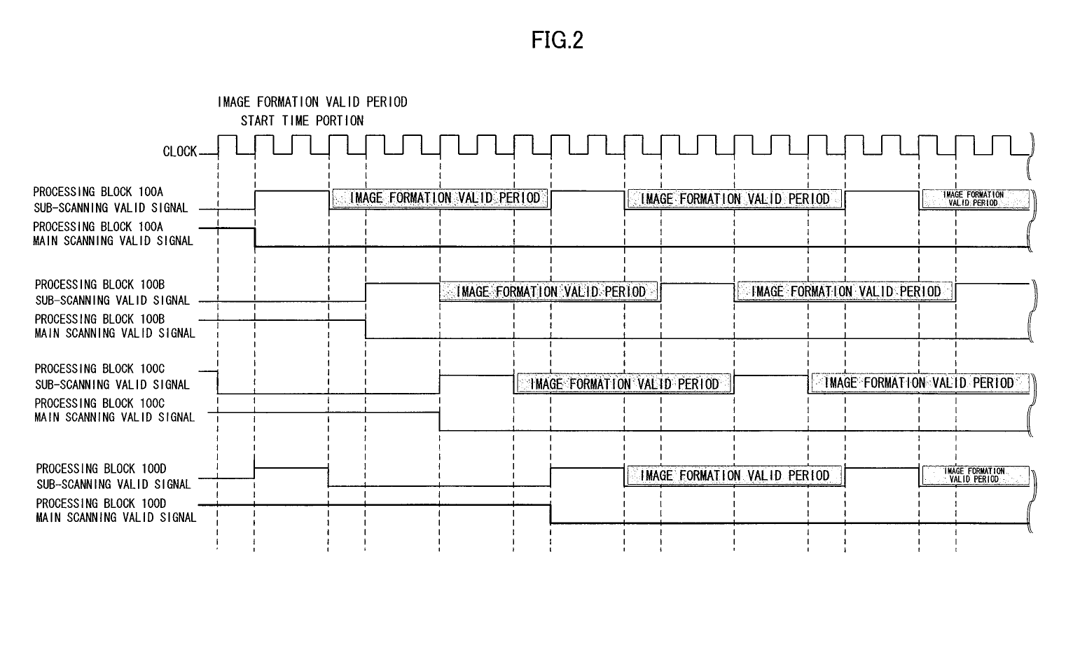

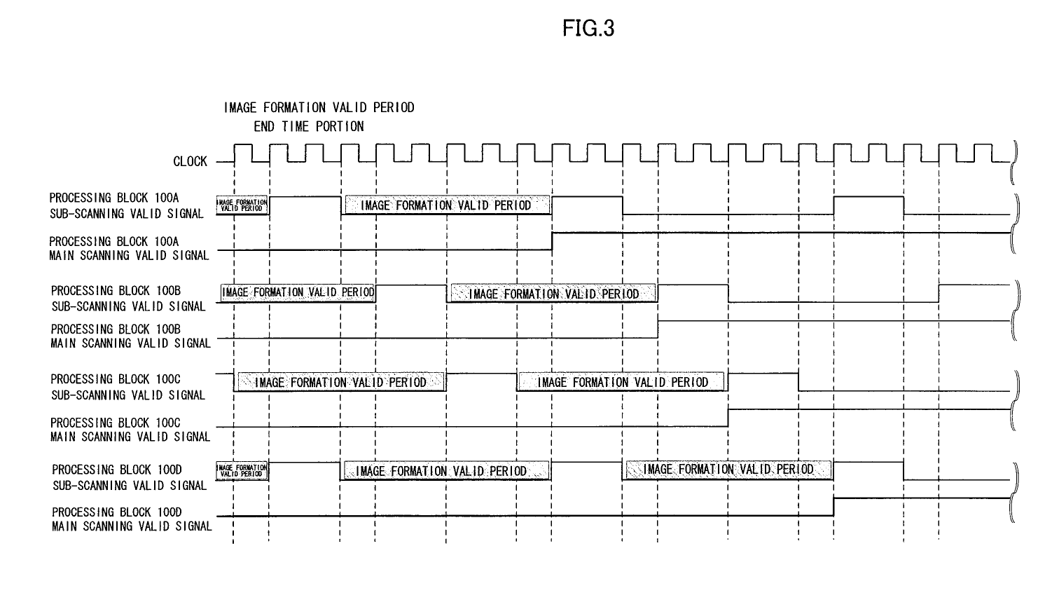

As an example, it is assumed that the processing block 100A performs “base processing”, the processing block 100B performs “filter processing”, the processing block 100C performs “gamma correction processing”, and the processing block 100D performs “expansion/reduction processing”. FIGS. 2 and 3 are diagrams showing changes in main scanning valid signals and sub-scanning valid signals serving as image valid signals at the time when an image data signal inputted to the processing block 100A is sequentially passed to the processing blocks at post-stages.

The clock period switching control section 200A has a function of reading image valid signals outputted from the processing blocks 100A to 100D in the ASIC 100, respectively, and judging a processing block from which an image valid signal is outputted as a processing block in which it is possible to stop processing (judging completion of processing concerning an image data signal in each of plural processing blocks). In this way, the clock period switching control section 200A judges completion of processing concerning an image data signal in each of plural processing blocks on the basis of an image valid signal outputted from the processing block.

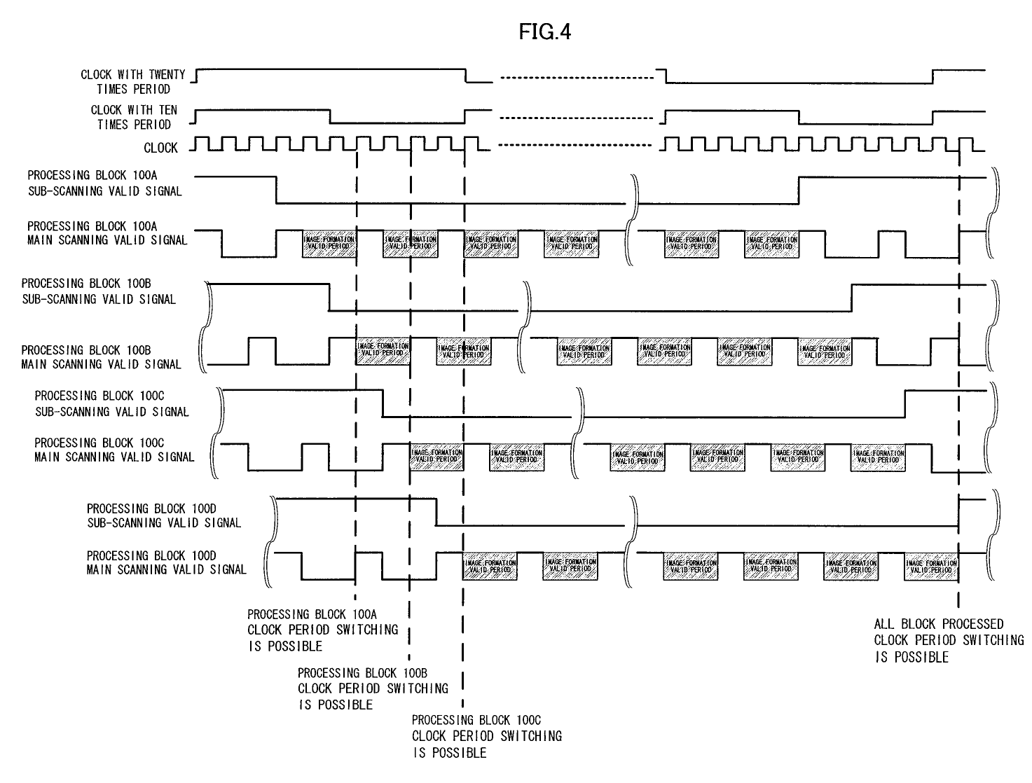

When it is judged in the judgment that processing in any one of the processing blocks is completed, the clock period switching control section 200A controls a frequency of a clock signal inputted to the processing block in which the processing is completed to be a second frequency lower than a usual frequency (a first frequency) of a clock signal that should be inputted when predetermined processing is performed in the processing block. FIG. 4 is a diagram for explaining judgment of completion of processing in processing blocks based on the image valid signals and frequency control for clock signals.

FIG. 4 shows timing when it is possible to switch a clock signal inputted to each of the processing blocks 100A to 100C on the basis of the image valid signals outputted from the processing blocks 100A to 100C to a “clock signal with ten times period” or a “cock signal with twenty times period” (equivalent to the second frequency) shown in FIG. 4.

The clock switch control judging section 300 has a role of judging the start of input of an image valid signal to the processing block 100A at a foremost stage among the plural processing blocks 100A to 100D.

When it is judged by the clock switching control judging section 300 that input of an image valid signal is started, the clock period switching control section 200A receives a clock period switching reset judgment signal from the clock switching control judgment section 300 and resets clock signals (clocks A to D) inputted to processing blocks, to which clock signals with the second frequency are inputted, to the first frequency.

A memory 901 is, for example, a Read Only Memory (ROM) or a Random Access Memory (RAM) and has a role of storing various kinds of information and programs used in the integrated circuit.

The clock period switching function will be schematically explained.

Since the processing of the processing blocks 100A to 100D is data processing synchronizing with a clock, processing for inputting data to the ASICS 100 changes to output of processed data after an output time involving a clock delay equivalent to a line delay for internal processing of the ASIC 100 and a clock delay related to the processing.

Therefore, the ASIC 100 that performs image processing and the like in the image processing apparatus performs data processing in valid image areas using image valid signals. Thus, the valid image areas (page images) are not continuously linked. In other words, from the start of first processing to the end of last processing, the processing block before the processing block at the rearmost stage does not need a processing clock for performing usual processing (a clock signal with the first frequency) until the processing block 100D at the rearmost stage ends output of processing data.

Thus, in a period in which any one of the processing block does not need the processing clock, the processing clock is divided into a frequency as close as possible to the stop to extend a clock period thereof. By supplying the processing clock with the clock period extended to the processing block, it is possible to reduce an operation ratio of the ASIC 100. As a result, it is possible to reduce power consumption.

In the integrated circuit according to this embodiment, the clock period switching function is controlled using image valid signals. Processing clocks are divided for the respective processing blocks 100A to 100D. The circuit of the ASIC 100 supplies the clocks for the respective processing blocks 100A to 100D to the respective processing blocks 100A to 100D for necessary periods using image valid signals according to the clock period switching function.

According to this embodiment, it is possible to perform separate automatic control for clock signals inputted to the respective processing blocks. Thus, even when the circuit in the ASIC 100 is divided into plural processing blocks, it is possible to perform careful clock period switching control using image valid signals outputted from the respective processing blocks 100A to 100D. Consequently, it is unnecessary to control the sleep function with the CPU and it is possible to easily control the sleep function of the ASIC 100 with a simple configuration and realize valid reduction of power consumption.

### SECOND EMBODIMENT

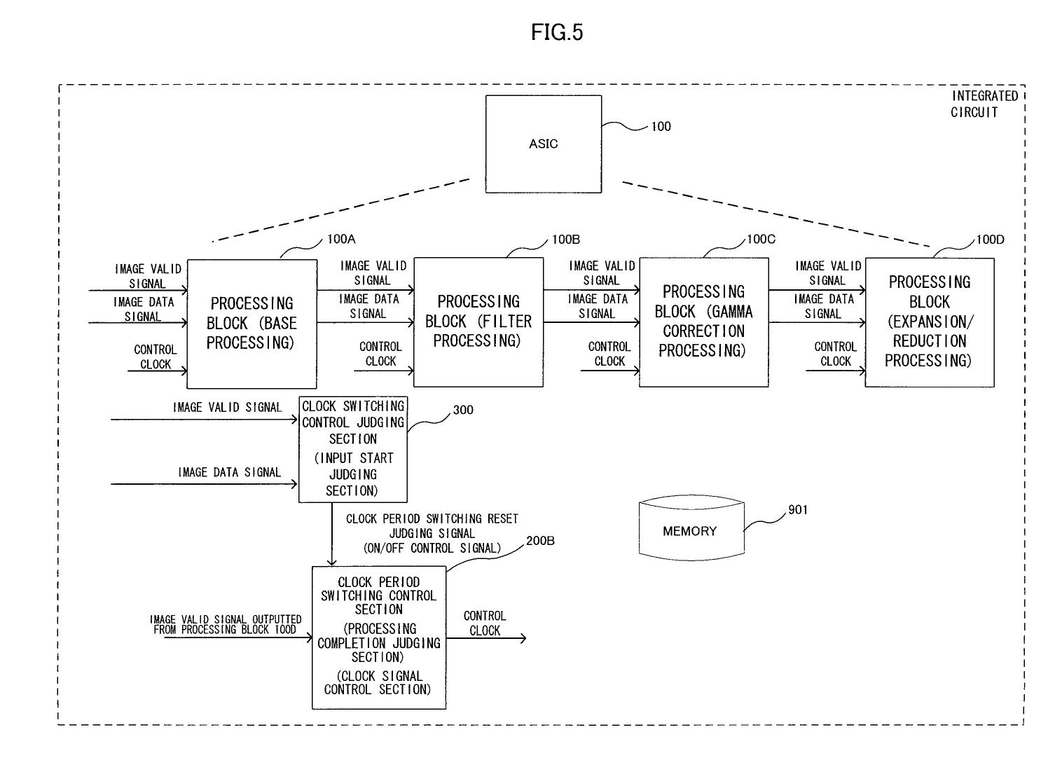

An integrated circuit according to a second embodiment of the invention will be explained. FIG. 5 is a block diagram showing a configuration of an integrated circuit according to this embodiment. In the integrated circuit according to this embodiment, a method of inputting a clock signal to plural processing blocks is different from that in the first embodiment. Components identical with those described in the first embodiment are denoted by the identical reference numerals and signs. Explanations of the components are omitted. Specifically, a clock period switching control section 200B is different from the clock period switching control section 200A in the first embodiment.

The integrated circuit according to this embodiment is the same as that in the first embodiment in that the integrated circuit controls a frequency of a clock signal supplied to the processing blocks on the basis of image valid signals outputted from the processing blocks. In this embodiment, taking into account a line delay time and a clock delay amount necessary for processing in all the processing blocks 100A to 100D in the internal circuit formed in the ASIC 100, after overall processing from input to output completion time for the ASIC 100 is completed, the plural processing blocks are simultaneously controlled as processing blocks in which it is possible to stop a processing function of one ASIC (so-called gated clock control).

The clock period switching control section (a processing completion judging section and a clock signal control section) 200B judges whether it is possible to stop processing in all the processing blocks (whether processing concerning an image data signal is completed) on the basis of an image valid signal outputted from the processing block 100D at the rearmost stage in the ASIC 100. When it is judged that the processing is completed, the clock period switching control section 200B starts the clock period switching function, switches frequencies of clock signals inputted to all the processing blocks 100A to 100D to the “clock signal with ten times period”, the “clock signal with twenty times period”, or the like shown in FIG. 4, and outputs clock signals with lowered frequencies to the processing blocks 100A to 100D (it is preferable that periods of the clock signals are as close as the stop).

In this embodiment, the clock period switching function of one ASIC is controlled. The function of the ASIC is mainly processing in image valid signals. Thus, it is possible to perform low power consumption control by performing processing that can be stopped as a function at the time when image processing is invalid taking into account all the processing blocks in the internal circuit according to control of the clock period switching function for processed portion of data and controlling to start the clock period switching function.

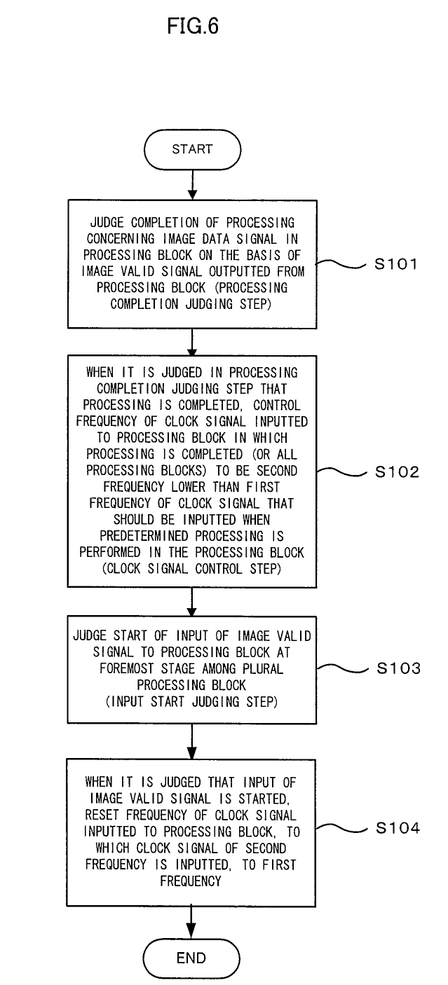

FIG. 6 is a flowchart for explaining a flow of processing (a clock signal control method) in the integrated circuit according to the respective embodiments described above.

The clock period switching control section judges completion of processing concerning an image data signal in each of the plural processing blocks 100A to 100D (or completion of processing concerning an image data signal in the processing block at the rearmost stage among the plural processing blocks) on the basis of an image valid signal outputted from the processing block (a processing completion judging step) (S101).

When it is judged in the processing completion judging step that the processing is completed, the clock period switching control section controls a frequency of a clock signal inputted to the processing block in which the processing is completed (or all the processing blocks) to be a second frequency lower than a first frequency of a clock signal that should be inputted when predetermined processing is performed in the processing block (a clock signal control step) (S102).

The clock switching control judging section judges the start of input of an image valid signal to a processing block at a foremost stage among the plural processing blocks (an input start judging step) (S103).

When it is judged that the input of an image valid signal is started, the clock period switching control section resets the frequency of the clock signal inputted to the processing block, to which the clock signal of the second frequency is inputted, to the first frequency (S104).

The respective steps in the processing in the integrated circuit are realized by causing a not-shown CPU or the respective components forming the integrated circuit according to this embodiment to execute a clock signal control program stored in the memory 109.

It goes without saying that it is possible to provide an image processing apparatus that realizes the effects by the integrated circuits according to the embodiments by providing an image processing unit such as an image forming unit or an image reading unit that performs predetermined image processing on the basis of results of processing in the processing blocks in the integrated circuits according to the embodiments.

In the explanation of this embodiment, a function for embodying the invention is recorded in advance in the apparatus. However, the invention is not limited to this. The same function may be downloaded to the apparatus from a network or the same function stored in a recording medium may be installed in the apparatus. Any form of the recording medium such as a CD-ROM may be adopted as long as the recording medium can store a program and is readable by the apparatus. The function obtained by the install or the download in advance in this way may be realized in cooperation with an Operating System (OS) in the apparatus.

Although the invention has been explained on the basis of the specific embodiments, it will be apparent to those having ordinary skills in the art that various alterations and modifications are possible without departing from the spirit

As described above, according to this embodiment, an operation state serving as a function of the ASIC is judged by using image valid signals and the start and reset control of the clock period switching function is performed to make it possible to reduce power consumption. A non-operation state of the internal circuit of the ASIC itself is judged according to image valid signals as one of ASIC functions without requiring control of the sleep (clock stop) function or the like by the CPU and a clock of a non-operating portion is controlled to be switched. This makes it possible to perform low power consumption control and finer control for the low power consumption function.

It is also possible to improve control time of a program for low power consumption control and a CPU or the like for low power consumption control.

On the basis of image effective signals outputted from the plural processing blocks constituting the ASIC, frequencies of clock signals inputted to the processing blocks are reduced rather than being stopped. This makes it possible to gradually pass image data or the like sequentially sent to the processing blocks to the processing blocks at the post-stages. Thus, a flow of image data is not completely stopped. Consequently, when image data are sent to the processing blocks one after another, the image data are processed without delay. It is possible to prevent a state in which image data or the like remain in the processing blocks because clock signals inputted to the processing blocks are completely stopped.

As described above in detail, according to the invention, it is possible to provide an integrated circuit that can easily realize efficient reduction of power consumption of an ASIC with a simple configuration without requiring control of a sleep function by a CPU and an image processing apparatus including the integrated circuit.

1. An integrated circuit that includes plural processing blocks for performing, on the basis of clock signals and image valid signals inputted, predetermined processing concerning image data signals inputted and sequentially outputs results of processing in processing blocks at pre-stages to the processing blocks at post-stages, the integrated circuit comprising:
a processing completion judging section that judges completion of processing concerning an image data signal in each of the plural processing blocks; and
a clock signal control section that controls, when the processing completion judging section judges that the processing is completed, a frequency of a clock signal inputted to the processing block in which the processing is completed to be a second frequency lower than a first frequency of a clock signal that should be inputted when the predetermined processing is performed in the processing block.

2. An integrated circuit that includes plural processing blocks for performing, on the basis of clock signals and image valid signals inputted, predetermined processing concerning image data signals inputted and sequentially outputs results of processing in processing blocks at pre-stages to the processing blocks at post-stages, the integrated circuit comprising:
a processing completion judging section that judges completion of processing concerning an image data signal in a processing block at a rearmost stage among the plural processing blocks; and
a clock signal control section that controls, when the processing completion judging section judges that the processing is completed, frequencies of clock signals inputted to the plural processing blocks to be a second frequency lower than a first frequency of a clock signal that should be inputted when the predetermined processing is performed in the processing block.

3. An integrated circuit according to claim 1, further comprising an input start judging section that judges a start of input of an image valid signal to a processing block at a foremost stage among the plural processing blocks,
wherein the clock signal control section resets, when the input start judging section judges that the input of the image valid signal is started, the frequency of the clock signal inputted to the processing block, to which the clock signal of the second frequency is inputted, to the first frequency.

4. An integrated circuit according to claim 1, wherein the processing completion judging section judges completion of processing concerning an image data signal in each of the plural processing blocks on the basis of an image valid signal outputted from the processing block.

5. An image processing apparatus comprising:
an integrated circuit according to claim 1; and
an image processing section that performs predetermined image processing on the basis of a result of processing in the processing block.

6. A clock signal control method in an integrated circuit that includes plural processing blocks for performing, on the basis of clock signals and image valid signals inputted, predetermined processing concerning image data signals inputted and sequentially outputs results of processing in processing blocks at pre-stages to the processing blocks at post-stages, the clock signal control method comprising:
a processing completion judging step of judging completion of processing concerning an image data signal in each of the plural processing blocks; and
a clock signal control step of controlling, when it is judged in the processing completion judging step that the processing is completed, a frequency of a clock signal inputted to the processing block in which the processing is completed to be a second frequency lower than a first frequency of a clock signal that should be inputted when the predetermined processing is performed in the processing block.

7. A clock signal control method in an integrated circuit that includes plural processing blocks for performing, on the basis of clock signals and image valid signals inputted, predetermined processing concerning image data signals inputted and sequentially outputs results of processing in processing blocks at pre-stages to the processing blocks at post-stages, the clock signal control method comprising:
a processing completion judging step of judging completion of processing concerning an image data signal in a processing block at a rearmost stage among the plural processing blocks; and
a clock signal control step of controlling, when it is judged in the processing completion judging step that the processing is completed, frequencies of clock signals inputted to the plural processing blocks to be a second frequency lower than a first frequency of a clock signal that should be inputted when the predetermined processing is performed in the processing block.

8. A clock signal control method according to claim 6, further comprising an input start judging step of judging a start of input of an image valid signal to a processing block at a foremost stage among the plural processing blocks,
wherein, in the clock signal control step, when it is judged in the input start judging step that the input of the image valid signal is started, the frequency of the clock signal inputted to the processing block, to which the clock signal of the second frequency is inputted, is reset to the first frequency.

9. A clock signal control method according to claim 6, wherein, in the processing completion judging step, completion of processing concerning an image data signal in each of the plural processing blocks is judged on the basis of an image valid signal outputted from the processing block.

10. A clock signal control program for causing a computer to execute control of a clock signal in an integrated circuit that includes plural processing blocks for performing, on the basis of clock signals and image valid signals inputted, predetermined processing concerning image data signals inputted and sequentially outputs results of processing in processing blocks at pre-stages to the processing blocks at post-stages, the clock signal control program causing the computer to execute:
a processing completion judging step of judging completion of processing concerning an image data signal in each of the plural processing blocks; and
a clock signal control step of controlling, when it is judged in the processing completion judging step that the processing is completed, a frequency of a clock signal inputted to the processing block in which the signal is outputted to be a second frequency lower than a first frequency of a clock signal that should be inputted when the predetermined processing is performed in the processing block.

11. A clock signal control program for causing a computer to execute control of a clock signal in an integrated circuit that includes plural processing blocks for performing, on the basis of clock signals and image valid signals inputted, predetermined processing concerning image data signals inputted and sequentially outputs results of processing in processing blocks at pre-stages to the processing blocks at post-stages, the clock signal control program causing the computer to execute:
a processing completion judging step of judging completion of processing concerning an image data signal in a processing block at a rearmost stage among the plural processing blocks; and
a clock signal control step of controlling, when it is judged in the processing completion judging step that the processing is completed, frequencies of clock signals inputted to the plural processing blocks to be a second frequency lower than a first frequency of a clock signal that should be inputted when the predetermined processing is performed in the processing block.

12. A clock signal control program according to claim 10, further comprising an input start judging step of judging a start of input of an image valid signal to a processing block at a foremost stage among the plural processing blocks,
wherein, in the clock signal control step, when it is judged in the input start judging step that the input of the image valid signal is started, the frequency of the clock signal inputted to the processing block, to which the clock signal of the second frequency is inputted, is reset to the first frequency.

13. A clock signal control program according to claim 10, wherein, in the processing completion judging step, completion of processing concerning an image data signal in each of the plural processing blocks is judged on the basis of an image valid signal outputted from the processing block.
